(19) United States
(12) Patent Application Publication
(10) Pub. No.: US 2009/0135084 A1
(43) Pub. Date: May 28, 2009

(54) Structure of dual symmetrical antennas

(76) Inventors: Chih-Yung Huang, Dongshih Township (TW); Shih-Chieh Cheng, Yongkang City (TW)

Correspondence Address: Muncy, Geissler, Olds & Lowe, PLLC, P.O. BOX 1364, FAIRFAX, VA, 22038-1364, US

(21) Appl. No.: 12/313,926

(22) Filed: Nov. 26, 2008

(30) Foreign Application Priority Data
Nov. 27, 2007 (TW) 96145041

(51) Int. Cl. H01Q 21/00

(52) U.S. Cl. 343/893

(57) ABSTRACT

A structure of dual symmetrical antennas adopted on a broadband product to operate within 2.0 GHz˜5.8 GHz, comprises a PCB, two first trapezoid antennas symmetrically aligned with one of parallel sides thereof on a surface of a PCB, and two second trapezoid antennas symmetrically aligned with each other with one of parallel sides thereof on another surface of the PCB opposite to the first trapezoid antennas, wherein the first trapezoid antennas and the second trapezoid antennas simultaneously enable the broadband product to operate at both a first frequency band and a second frequency band, and the second frequency band overlaps a part of the first frequency band.

### CROSS REFERENCE TO RELATED APPLICATIONS

This application claims priority to Taiwan Application Serial Number 96145041, filed Nov. 27, 2007, which is herein incorporated by reference.

### BACKGROUND OF THE INVENTION

1. Field of the Invention

This invention is related to a structure of a wideband antenna, and more particularly to a structure of dual symmetrical antennas for a broadband product providing a wide range band.

2. Brief Description of the Related Art

The conventional antennas of broadband products implemented in Worldwide Interoperability for Microwave Access (WiMAX) system normally provide bandwidth as follows:

(1) Licensed Band:

Wireless Communication Services (WCS) system for U.S.A.: 305-2.320 GHz, 2.345-2.360 GHz; Multi-point Microwave Distribution System or Multi-channel Multi-point Distribution System (MMDS) system for U.S.A.: 2.50-2.69 GHz; and International Fixed Wireless Access (FWA) system: 3.4-3.7 GHz.

(2) Unlicensed Band:

2.4 GHz industrial, scientific and medical (ISM) system: 2.4000-2.4835 GHz; 5 GHz Unlicensed National Information Infrastructure (U-NII) system: 5.15-5.35 GHz, 5.470-5.725 GHz and 5.725-5.825 GHz; and International Fixed Wireless Access (FWA) system: 3.4-3.7 GHz.

(3) Ultra-WideBand (UWB) system applied in IEEE 802.15.3a operates at the band of 3.1 GHz-4.8 GHz of a high speed, short distance and low mobility of wireless communication systems.

However, according to U.S. Pat. No. 7,230,578 “dual-band dipole antenna” and U.S. Pat. No. 7,242,352 “Multi-band or wide-band antenna”, the citation U.S. Pat. No. 7,230,578 discloses that its dual-band dipole antenna enables to operate at 2.3 GHz˜2.6 GHz or 5 GHz˜6 GHz but fails to operate at 2.3 GHz˜2.6 GHz and 5 GHz˜6 GHz simultaneously, and the another citation U.S. Pat. No. 7,242,352 discloses that its multi-band or wide-band antenna enables to operate at 2.4 GHz, 5.4 GHz or 2.9 GHz, 6.2 GHz but fails to operate at 2.4 GHz˜6 GHz simultaneously.

Therefore, people who are dedicated in this industry conduct considerable research and experimentation to provide a broadband antenna capable of operating at a band covering the bandwidth introduced above.

### SUMMARY OF THE INVENTION

It is therefore an objective of the present invention to present a structure of dual symmetrical antennas, thus it provides a wide range of frequency bandwidth within 2.1 GHz˜6 GHz for fully covering the bandwidths in WiMAX system

To achieve the foregoing objectives, the present invention is to provide a structure of dual symmetrical antennas adopted on a broadband product to operate at a frequency bandwidth within 2.0 GHz˜5.8 GHz. The structure of dual symmetrical antennas comprises a printed circuit board (PCB), two first trapezoid antennas symmetrically aligned with one of the parallel sides thereof on a surface of a PCB, and two second trapezoid antennas symmetrically aligned with each other with one of the parallel sides thereof on another surface of the PCB opposite to the first trapezoid antennas, wherein the first trapezoid antennas and the second trapezoid antennas simultaneously enable the broadband product to operate at both a first frequency band and a second frequency band, and the second frequency band overlaps a part of the first frequency band.

Therefore, the present invention of the dual symmetrical antennas provides a wide range of band within 2.0 GHz˜5.8 GHz to fit in all bands in WiMAX system.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will become more fully understood from the following detailed description and the accompanying drawings, which are given by way of illustration only, and thus are not limitative of the present invention, and where:

FIG. 1 is a perspective view of a structure of dual symmetrical antennas according to the present invention;

FIG. 2 is a top view on a PCB of a structure of dual symmetrical antennas according to the present invention;

FIG. 3 is a bottom view on a PCB of a structure of dual symmetrical antennas according to the present invention;

FIG. 4 is an oscillogram chart of VSWR of the dual symmetrical antennas according to the present invention;

FIG. 5a is a horizontally polarized principle plane radiation pattern of the dual symmetrical antennas operating at the resonant frequency of 2.1 GHz˜2.7 GHz;

FIG. 5b is a horizontally polarized principle plane radiation pattern of the dual symmetrical antennas operating at the resonant frequency of 3.1 GHz˜3.7 GHz;

FIG. 5c is a horizontally polarized principle plane radiation pattern of the dual symmetrical antennas operating at the resonant frequency of 4.1 GHz˜4.7 GHz;

FIG. 5d is a horizontally polarized principle plane radiation pattern of the dual symmetrical antennas operating at the resonant frequency of 5.1 GHz˜5.8 GHz;

FIG. 6a is a vertically polarized principle plane radiation pattern of the dual symmetrical antennas operating at the resonant frequency of 2.1 GHz˜2.7 GHz;

FIG. 6b is a vertically polarized principle plane radiation pattern of the dual symmetrical antennas operating at the resonant frequency of 3.1 GHz˜3.7 GHz;

FIG. 6c is a vertically polarized principle plane radiation pattern of the dual symmetrical antennas operating at the resonant frequency of 4.1 GHz˜4.7 GHz; and

FIG. 6d is a vertically polarized principle plane radiation pattern of the dual symmetrical antennas operating at the resonant frequency of 5.1 GHz˜5.8 GHz.

### DETAILED DESCRIPTION OF THE PREFERRED EMBODIMENTS

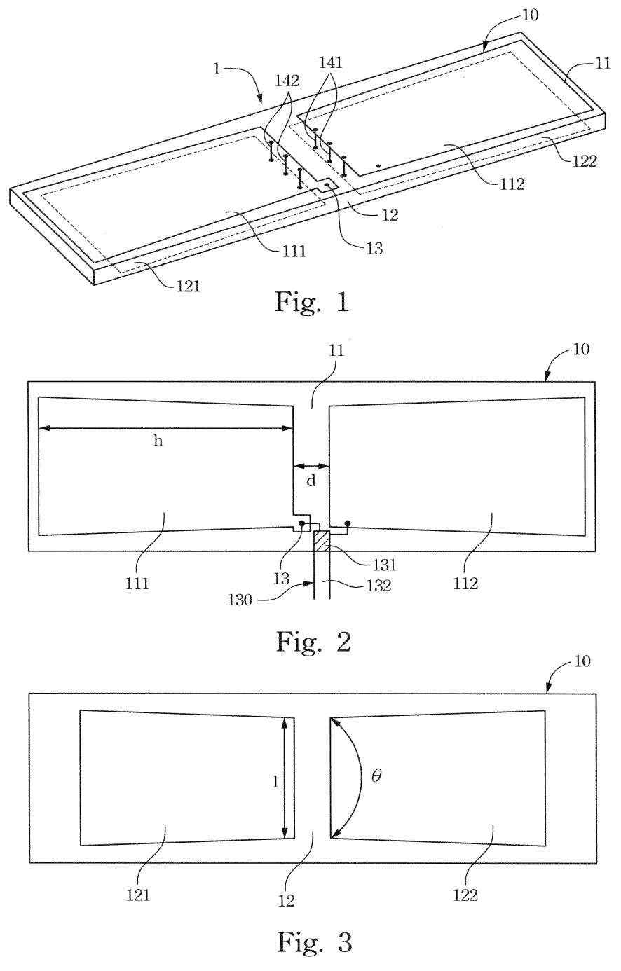

Referring to FIG. 1-3 in which FIG. 1 is a perspective view of a structure of dual symmetrical antennas according to the present invention, FIG. 2 is a top view on a PCB of a structure of dual symmetrical antennas according to the present invention and FIG. 3 is a bottom view on a PCB of a structure of dual symmetrical antennas according to the present invention. In FIG. 1-3, a structure 1 of dual symmetrical antennas is disclosed, and includes a printed circuit board (PCB) 10 having a first surface 11 and a second surface 12 opposite to the first surface 11, wherein two first trapezoid antennas, named left first trapezoid antenna 111 and right first trapezoid antenna 112, are symmetrically aligned with each other with one of parallel sides (longer one or shorter one) thereof on the first surface 11, and two second trapezoid antennas, named left second trapezoid antenna 121 and right second trapezoid antenna 122, are symmetrically aligned with each other with one of parallel sides (longer one or shorter one) thereof on the second surface 12.

Moreover, the first trapezoid antennas 111, 112 separately electronically connect to one of the second trapezoid antennas 121, 122 positioned on the PCB 10 as the same direction as one first trapezoid antennal 11 or 112 via at least a conductive wire 141 or 142 penetrated through the PCB 10. It means that the one or more conductive wires 142 penetrate through the PCB 10 to achieve electrical connection between the left first trapezoid antenna 111 and the left second trapezoid antenna 121, and another one or more conductive wires 141 penetrate through the PCB 10 to achieve electrical connection between the right first trapezoid antenna 112 and the right second trapezoid antenna 122.

The first trapezoid antennas 111, 112 are provided to sending data out and receiving data from outside at a first frequency band and the second trapezoid antennas 121, 122 are provided to sending data out and receiving data from outside at a second frequency band. The second frequency band overlaps a part of the first frequency band.

In a preferred embodiment of the invention, it suggests that the structure 1 of dual symmetrical antennas is an embedded or a detachable type of antenna device adopted on a broadband product, for instance a network interface card, and at the moment the structure 1 of dual symmetrical antennas is produced, first mounting the elements and printing signal traces on the PCB 10 for building a broadband product, then producing two first symmetrical trapezoid antennas 111, 112 with same size and same shape and aligned symmetrically with each other on the first surface 11 of the PCB 10 by metal micro-strips, next producing two second symmetrical trapezoid antennas 121, 122 with same size and same shape and aligned symmetrically with each other on the second surface 12 of the PCB 10 by metal micro-strips.

Referring to FIG. 2 again; in the PCB 10 the conductive wires 141 or 142 that respectively penetrate through the PCB 10 from the first surface 11 to the second surface 12 thereof start from the parallel sides of the first trapezoid antennas 111 or 112 symmetrically aligned with. An RF feed point 13 is arranged on the parallel side of the left first trapezoid antenna 111 that is approximate to the right first trapezoid antennal 12. The RF feed point 13 is electrically connecting with a conductive end 131 of a conductive cord 130 having a ground end 132 electrically connected to the right first trapezoid antenna 112. It should be known that the RF feed point 13 could be arranged on any position of the parallel side of the first surface 11 thereof.

Since the first trapezoid antennas 111, 112 of the first surface 10 thereof enable the broadband product operating data receiving and sending at the first frequency band within 2.0˜3.3 GHz, and the second trapezoid antennas 121, 122 of the second surface 12 thereof enable the broadband product operating data receiving and sending at the second frequency band within 3.0˜5.8 GHz, thus, the structure 1 of the dual trapezoid antennas succeeds to cover a wide range of band width for 3.8 GHz (5.8-2.0 GHz) to provide data receiving and sending operations within those frequency bands.

As shown in FIGS. 2 and 3 again, in the structure 1 of the dual symmetrical antennas there are some factors discussed below to determine the first or second frequency band, its frequency bandwidth and frequency start point:

(A) factors of a length (l) of the parallel sides that the first trapezoid antennas 111, 112 are symmetrically aligned with each other with, and a gap distance (d) between the parallel sides that the first trapezoid antennas 111,112 are symmetrically aligned with each other with, are determined to affect the frequency bandwidth and the frequency start point of the frequency band for both sides symmetrical trapezoid antennas.

In this embodiment, the length (l) of the parallel sides that the first trapezoid antennas 111,112 are symmetrically aligned with each other with, is provided between 8˜11 mm and the gap distance (d) between the parallel sides that the first trapezoid antennas 111,112 are symmetrically aligned with each other with is provided between 1.5˜5.5 mm.

Thus, the frequency bandwidth of the first frequency band can be determined to 1.3 GHz and the frequency start point of the first frequency band can be determined to 2.0 GHz. On the other hand, the length (l) of the parallel sides that the second trapezoid antennas 121, 122 are symmetrically aligned with each other with is provided between 6˜11 mm and the gap distance (d) between the parallel sides that the second trapezoid antennas 121, 122 are symmetrically aligned with each other with is provided between 0.5˜5.5 mm. Thus, the frequency bandwidth of the second frequency band can be determined to 2.8 GHz and the frequency start point of the second frequency band can be determined to 3.0 GHz.

(B) factors of a height (h) and an open angle (θ) of each trapezoid antenna, are determined to affect the frequency band of both sides of symmetrical trapezoid antennas.

In this embodiment, the height (h) of each first trapezoid antenna 111 or 112 is provided between 18˜30 mm and the open angle (θ) of each first trapezoid antenna 111 or 112 is provided between 1.2 degree˜6.2 degree. Thus, the first frequency band can be determined to within 2.0˜3.3 GHz. On the other hand, the height (h) of each second trapezoid antenna 121 or 122 is provided between 12˜25 mm and the open angle (θ) of each second trapezoid antenna 121 or 122 is provided between 1.2 degree˜6.2 degree. Thus, the second frequency band can be determined to within 3.0˜5.8 GHz.

Therefore, by manipulating the factors of length (l), gap distance (d), height (h) and open angle (θ) thereof on the structure 1 of the dual symmetrical trapezoid antennas in a determined ratio of size, the structure 1 of the dual symmetrical trapezoid antennas is allowed to achieve the desired frequency band (even happened to reach 7.0 GHz), bandwidth and frequency start point. Also, the size of the first symmetrical trapezoid antennas 111, 112 is unnecessarily the same as the size of the second symmetrical trapezoid antennas 121, 122.

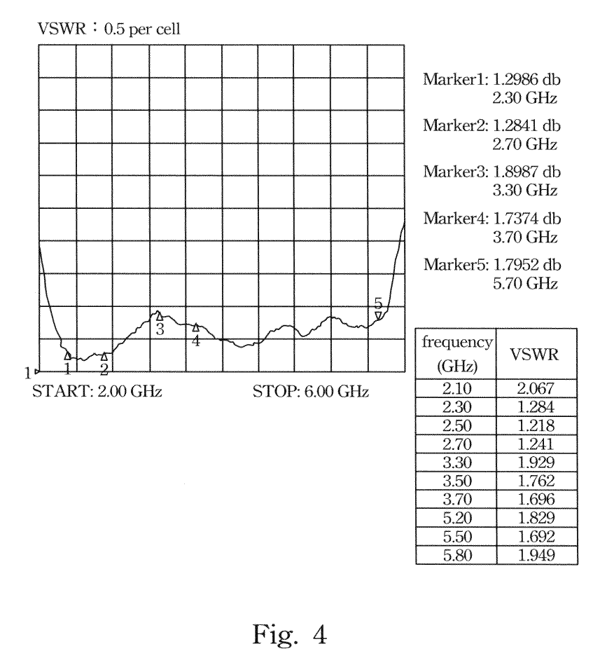

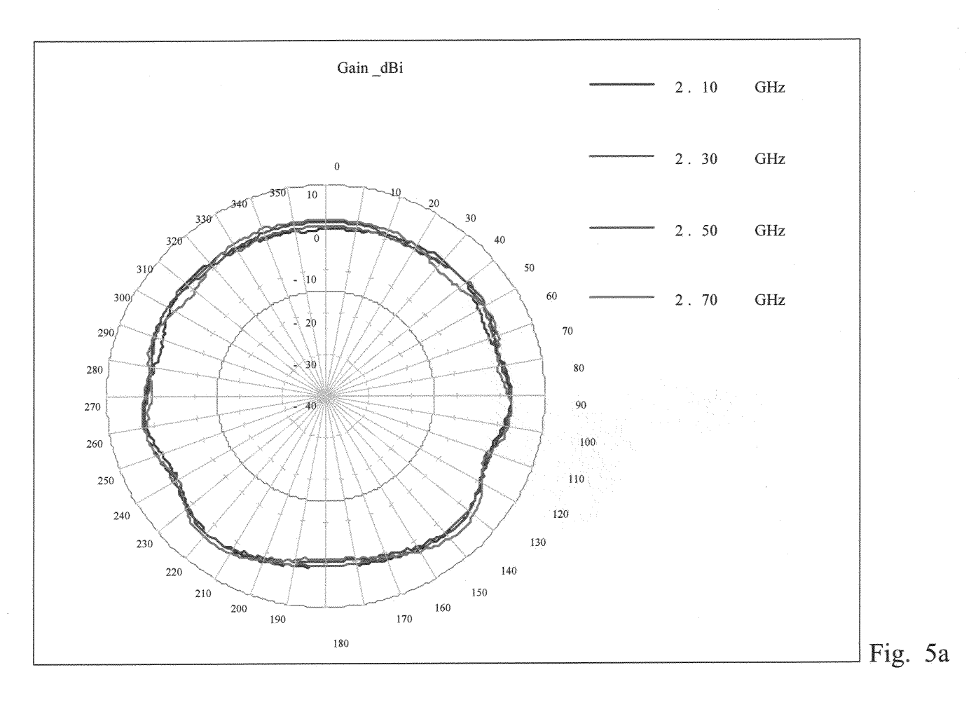

Based on the environment of the factors provided above, a finished product of the dual symmetrical trapezoid antennas is produced and an experiment of the finished product is made to test the performance of the structure 1 of dual symmetrical trapezoid antennas. The results, FIG. 4 are shown by an oscillogram chart of VSWR of the dual symmetrical trapezoid antennas according to the present invention.

The first symmetrical trapezoid antennas 111, 112 on the first surface 11 of the PCB 10 gain a good frequency response between 2.0 GHz˜3.3 GHz as the first frequency band. Only a Voltage Standing Wave Ratio (VSWR) at 2.1 GHz out of the first frequency band is 2.067 that unfits to a criterion of 2.0, the rests of VSWR in the first frequency band all fit to the criterion of 2.0. On the other hand, the second symmetrical trapezoid antennas 121, 122 on the second surface of the PCB 10 gain a good frequency response between 3.0 GHz˜5.8 GHz as the second frequency band, and all VSWR in the second frequency band fit the criterion of 2.0. Therefore, the structure 1 of the dual symmetrical trapezoid antennas fully covers a wide range of frequency bandwidth of 3.8 GHz.

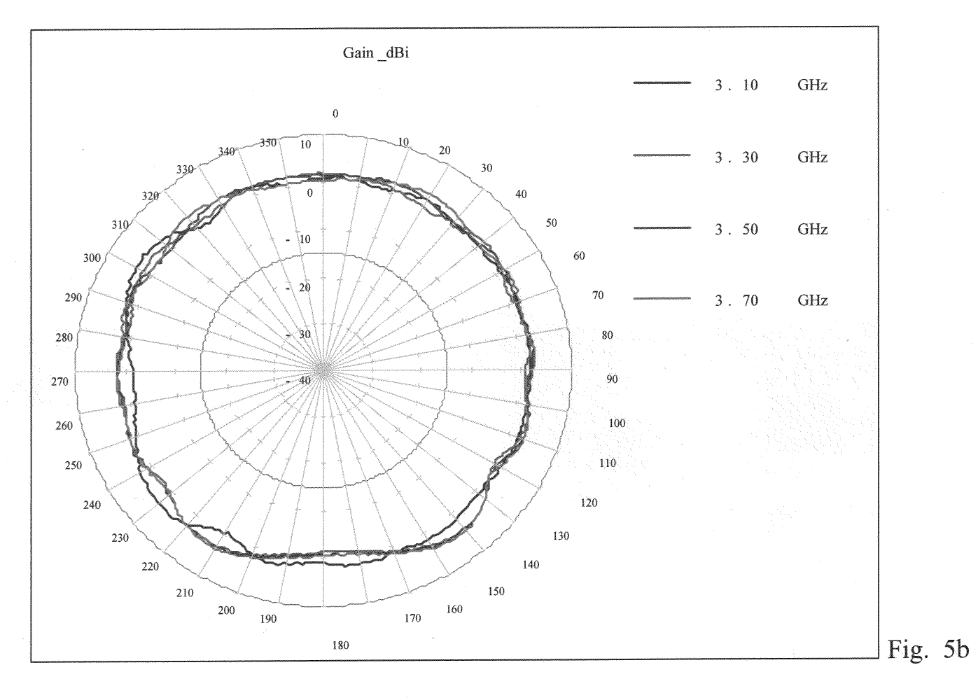

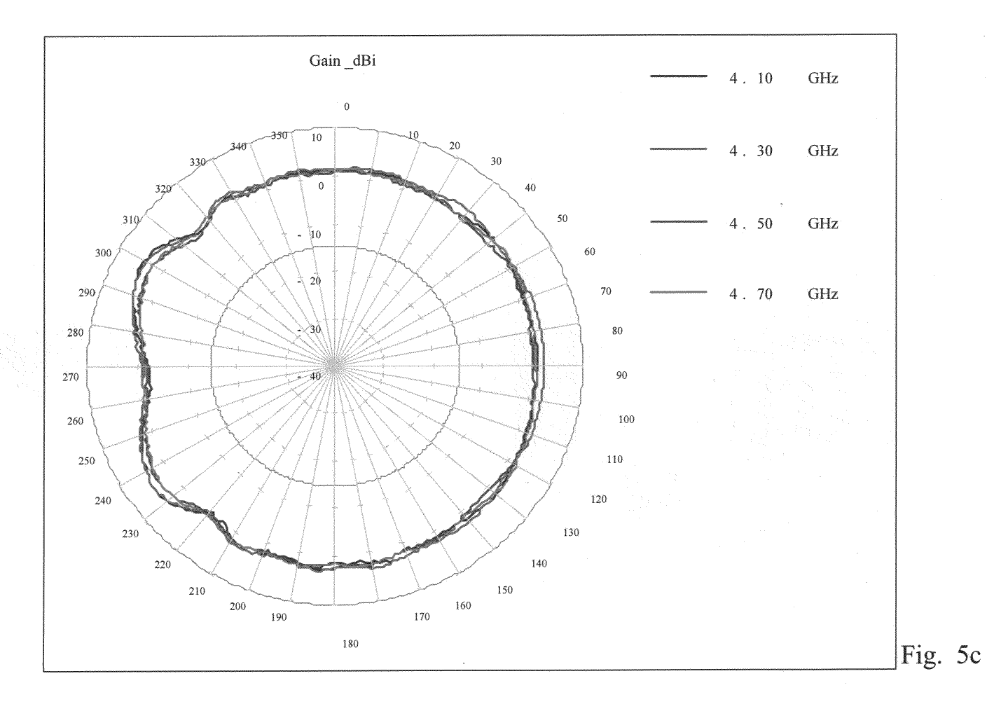

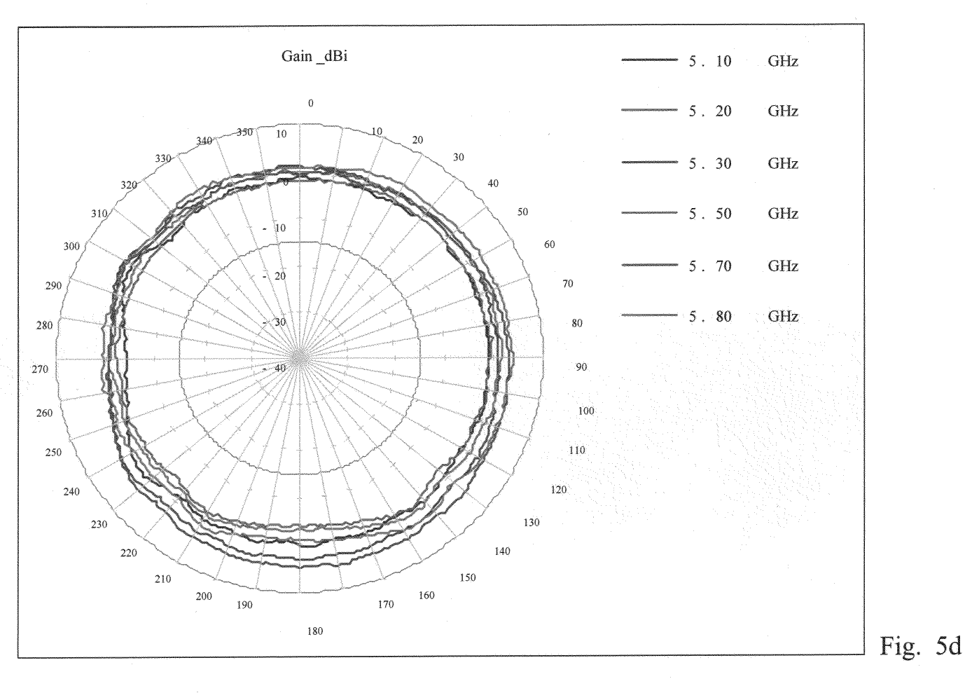

In order to show the utility of the structure 1 of the dual symmetrical trapezoid antennas with each section between 2.0˜5.8 GHz, a few horizontally polarized principle plane radiation patterns of the dual symmetrical antennas which separately operate at the resonant frequency of 2.1 GHz˜2.7 GHz, 3.1 GHz˜3.7 GHz, 4.1 GHz˜4.7 GHz and 5.1 GHz˜5.8 GHz in an antenna propagation lab, are respectively provided in FIG. 5a˜5d. In FIG. 5a˜5d, an average gain of horizontally polarized principle plane for the dual symmetrical trapezoid antennas is approximate to +2.0˜−1.0 decibel (dB), It shows that the structure 1 of the dual symmetrical trapezoid antennas is in a good condition and able to provide a good performance to operate within 2.0 GHz˜5.8 GHz.

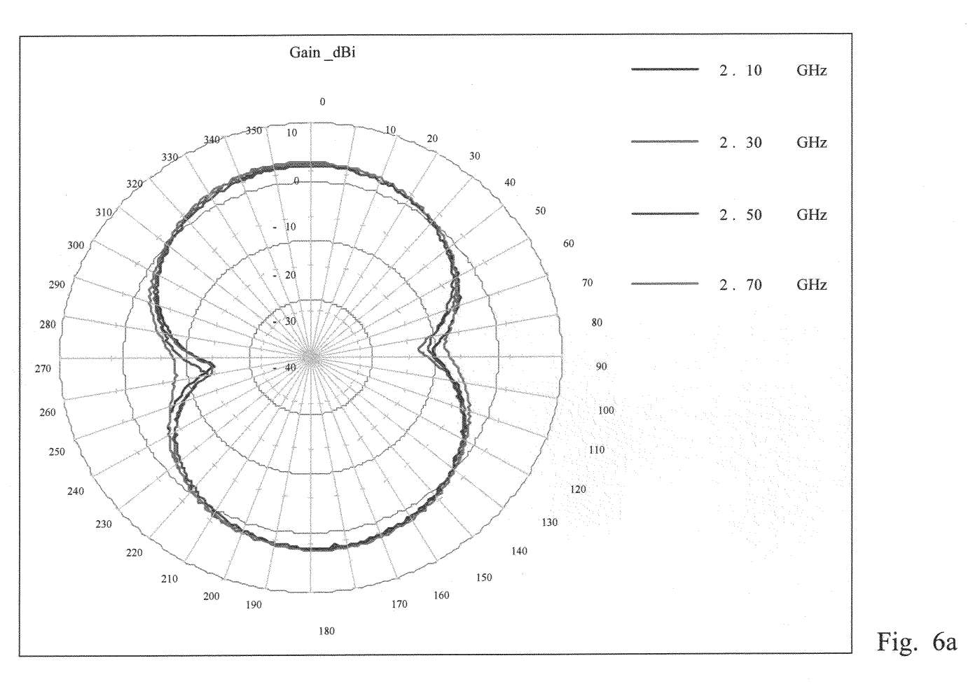

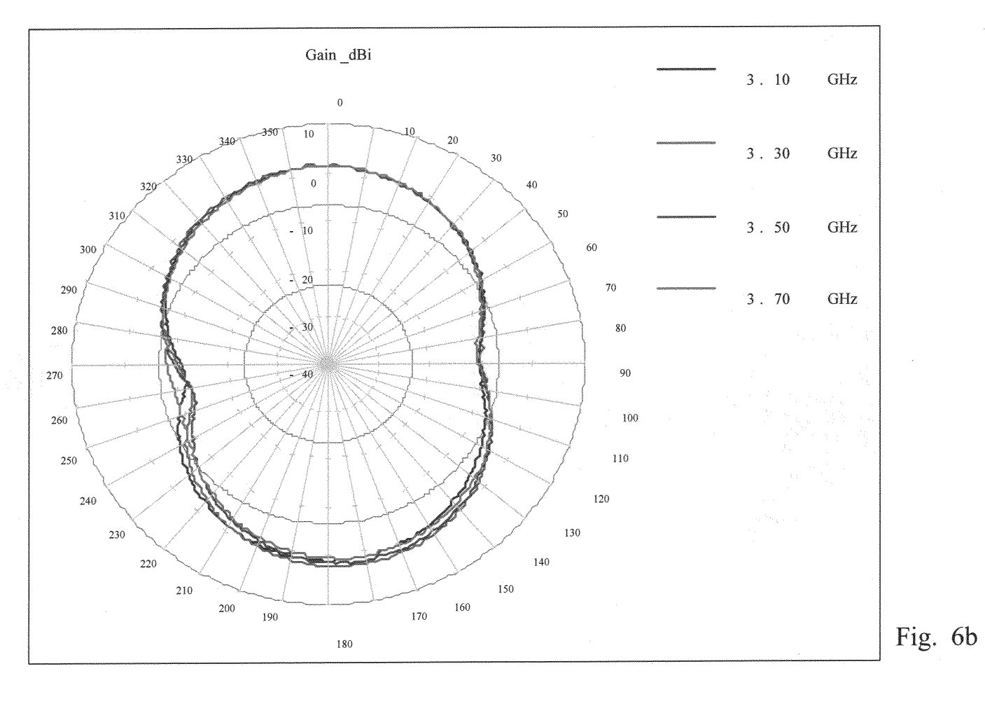

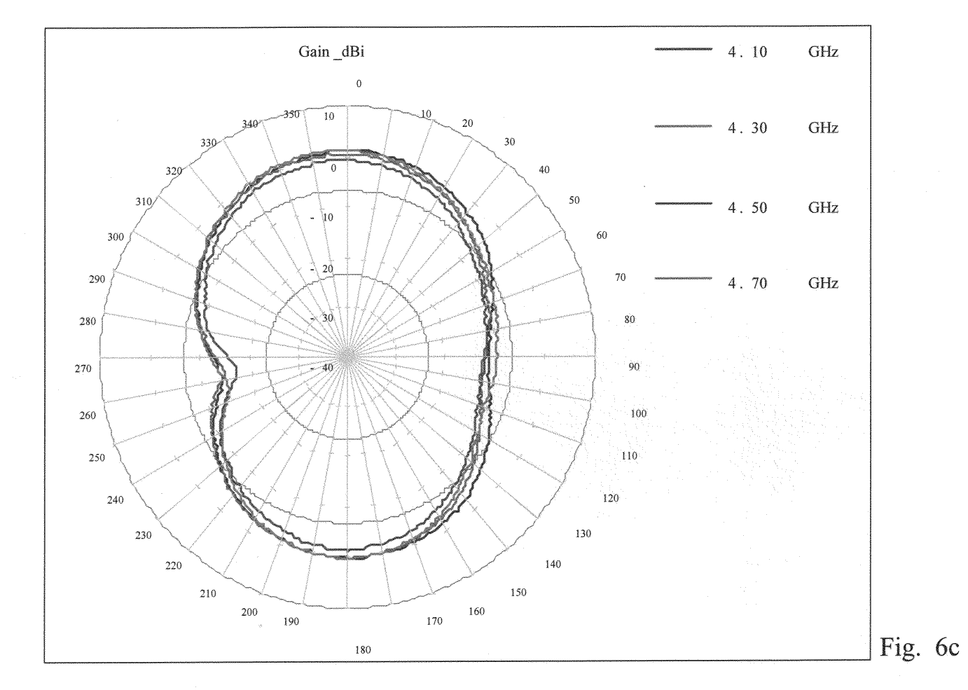

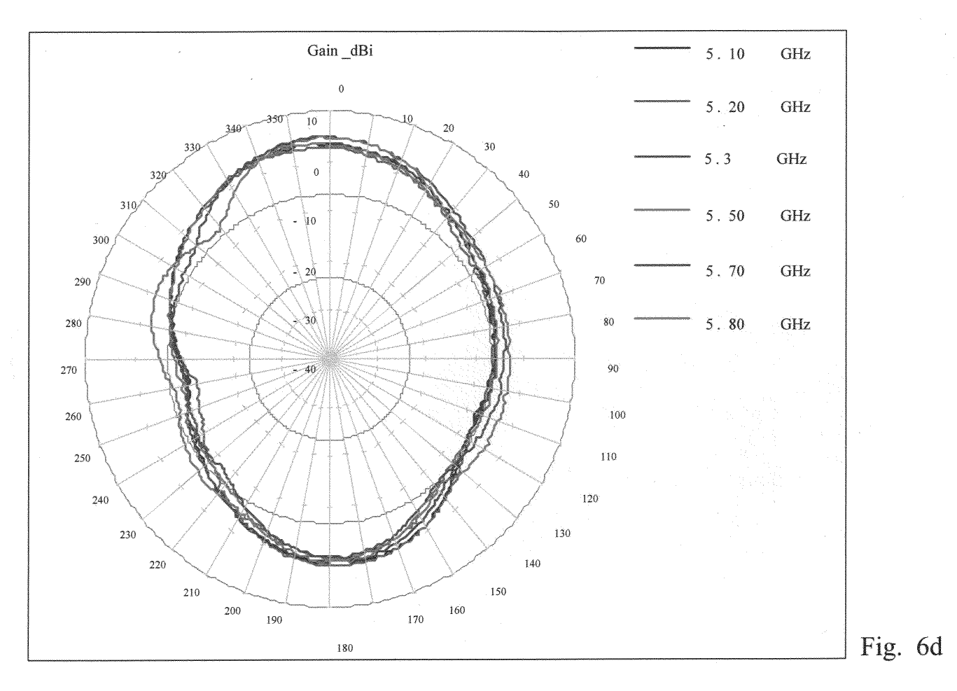

A few vertically polarized principle plane radiation patterns of the dual symmetrical antennas which separately operate at the resonant frequency of 2.1 GHz˜2.7 GHz, 3.1 GHz˜3.7 GHz, 4.1 GHz˜4.7 GHz and 5.1 GHz˜5.8 GHz in an antenna propagation lab, are respectively provided in FIG. 6a˜6d. Simultaneously referring to FIG. 6a˜6d, an average gain of vertically polarized principle plane for the dual symmetrical trapezoid antennas is approximate to −1.0˜−2.0 decibel (dB). It shows that the structure 1 of the dual symmetrical trapezoid antennas is in a good condition and able to provide a good performance to operate within 2.0 GHz˜5.8 GHz

Finally, the present invention with fully covering a wide range of frequency band of 2.0 GHz˜5.8 GHz not only provides enough rang of frequency band but also enhances efficiently the performance of the broadband product when the broadband product is applying a protocol such as IEEE 802.11a/b/g/n, WiMAX, Ultra Wide Band or Bluetooth.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A structure of dual symmetrical antennas adopted on a broadband product, the structure of dual symmetrical antennas comprising:
a printed circuit board (PCB);
two first trapezoid antennas symmetrically aligned with each other with one of parallel sides thereof on a surface of the PCB, wherein the two first trapezoid antennas are provided to operate data sending and receiving at a first frequency band;
two second trapezoid antennas symmetrically aligned with each other with one of parallel sides thereof on another surface of the PCB opposite to the first trapezoid antennas, and separately electronically connected to one of the first trapezoid antennas positioned on the PCB as the same direction as one second trapezoid antenna via at least a conductive wire through the PCB, wherein the two second trapezoid antennas are provided to operate data sending and receiving at a second frequency band overlapping a part of the first frequency band.

2. The structure as claimed in claim 1, wherein the first trapezoid antennas symmetrically are aligned with each other with a shorter one of parallel sides thereof.

3. The structure as claimed in claim 1, wherein the first trapezoid antennas symmetrically are aligned with each other with a longer one of parallel sides thereof.

4. The structure as claimed in claim 1, wherein a length of the parallel sides that the first trapezoid antennas are symmetrically aligned with each other with, and a gap distance between the parallel sides that the first trapezoid antennas are symmetrically aligned with each other with, are factors to determine a frequency bandwidth and a frequency start point of the first frequency band.

5. The structure as claimed in claim 4, wherein the length of the parallel sides that the first trapezoid antennas are symmetrically aligned with each other with is between 8˜11 mm, and the gap distance between the parallel sides that the first trapezoid antennas are symmetrically aligned with each other with is between 1.5˜5.5 mm.

6. The structure as claimed in claim 1, wherein a height of the first trapezoid antennas and an open angle of the first trapezoid antennas are factors to determine the first frequency band.

7. The structure as claimed in claim 6, wherein the height of the first trapezoid antennas is between 18˜30 mm, and the open angle of the first trapezoid antennas is between 1.2˜6.2 degree.

8. The structure as claimed in claim 1, wherein the second trapezoid antennas are symmetrically aligned with each other with a shorter one of parallel sides thereof.

9. The structure as claimed in claim 1, wherein the second trapezoid antennas are symmetrically aligned with each other with a longer one of parallel sides thereof.

10. The structure as claimed in claim 1, wherein a length of the parallel sides that the second trapezoid antennas are symmetrically aligned with each other with, and a gap distance between the parallel sides that the second trapezoid antennas are symmetrically aligned with each other with, are factors to determine a frequency bandwidth and a frequency start point of the second frequency band.

11. The structure as claimed in claim 10, wherein the length of the parallel sides that the second trapezoid antennas are symmetrically aligned with each other with is between 6˜11 mm, and the gap distance between the parallel sides that the second trapezoid antennas are symmetrically aligned with each other with is between 0.5˜5.5 mm.

12. The structure as claimed in claim 1, wherein a height of the second trapezoid antennas and an open angle of the second trapezoid antennas are factors to determine the second frequency band.

13. The structure as claimed in claim 12, wherein the height of the second trapezoid antennas is between 12˜25 mm, and the open angle of the second trapezoid antennas is between 1.2˜6.2 degree.

14. The structure as claimed in claim 1 further comprises an RF feed point, the RF feed point is arranged on the parallel side of one first trapezoid antenna approximate to another first trapezoid antenna.

15. The structure as claimed in claim 1, wherein the conductive wires that penetrates through the PCB are respectively from the parallel sides that the second trapezoid antennas are symmetrically aligned with each other with.
